(19) United States
(12) Patent Application Publication
(10) Pub. No.: US 2015/0120464 A1
(43) Pub. Date: Apr. 30, 2015

(54) INTERCONNECTED PLATFORM FOR PROVIDING ADVERTISEMENTS

(71) Applicant: Cox Communications, Inc., Atlanta, GA (US)

(72) Inventors: Michael R. Zeigler, Atlanta, GA (US); Dorothy N. Buie, Atlanta, GA (US); Leslie H. Talansky, Atlanta, GA (US); William F. Farina, Atlanta, GA (US)

(73) Assignee: Cox Communications, Inc., Atlanta, GA (US)

(21) Appl. No.: 14/065,604

(22) Filed: Oct. 29, 2013

(51) Int. Cl. G06Q 30/02

(52) U.S. Cl. CPC G06Q 30/0269
USPC 705/14.66

(57) ABSTRACT

Systems and methods for generating, selling, executing terms of ad demographic bins are disclosed. Ad demographic bins may be sold to ad buyer and may represent a variety of parameters and/or terms to which the ad demographic bin seller may have to perform. The ad demographic bins may specify a number of views, a targeted geography of those views, and/or a targeted demographic of those views. Once an ad demographic bin is sold, one or more ad avails, spots, and/or other ad assets may be acquired, such as from media and/or content providers for the purpose of rendering one or more ads on behalf of the ad buyer. The ad avails, spots, and/or other ad assets may be selected and/or acquired in a manner as to perform to the parameters of the ad demographic bin.

### TECHNICAL FIELD

This disclosure generally relates to interconnected platforms for providing advertisements.

### BACKGROUND

Advertising is often sold and displayed before, during, and/or after providing and/or rendering media content, such as audio and/or video, to a consumer of the of the media content. This advertising may be provided and/or sold for rendering by media providers. An example of a prior art mechanism for providing and/or selling advertisements (ads) is depicted in FIG. 1. FIG. 1 is a simplified schematic diagram of an example prior art environment 100 for selling advertisements by an ad broker 110 to a variety of ad buyers 120(1), 120(N), hereinafter individually or collectively referred to as ad buyer(s) 120. The ads may be sold by the ad broker 110 as spots 122 sold to the ad buyer 120.

The spots 122 may be associated with a particular multiple-system operator (MSO) 124(1), 124(N), hereinafter individually or collectively referred as an MSO 124. Therefore, the ad broker 110 may be serving as an intermediary between one or more MSOs and one or more ad buyers 120 to sell spots 122. The spots 122 that are sold may further be associated with a particular geographic location 126, 128, such as where a corresponding MSO 124 has network coverage. The spots 122 sold to the ad buyers 120 may correspond to a time slot 130, 132, 134, 136, 138, 140 on a particular channel 150, 152. Therefore, when an ad buyer 120 purchases a spot 122 from the ad broker 110, the ad buyer can insert an ad impression in that purchased spot 122 on the particular channel 150, 152 and time slot 130, 132, 134, 136, 138, 140 corresponding to the spot 122 sold by the ad broker 110 and purchased by the as buyer 120.

The spots 122, as they are associated with a particular channel 150, 152, time slot 130, 132, 134, 136, 138, 140, and geography 126, 128, may generally be monetized effectively for particular channels 160, such as channels 162 with relatively high viewership versus channels 164 with a relatively lower viewership. In some cases, ad buyers may not be amenable to place ads, or otherwise purchase ad slots on the channels with relatively lower viewership.

### BRIEF DESCRIPTION OF THE FIGURES

Reference will now be made to the accompanying drawings, which are not necessarily drawn to scale, and wherein:

FIG. 1 is a simplified schematic diagram illustrating a prior art mechanism of buying and selling advertisement spots between an advertisement broker and one or more advertisement buyers.

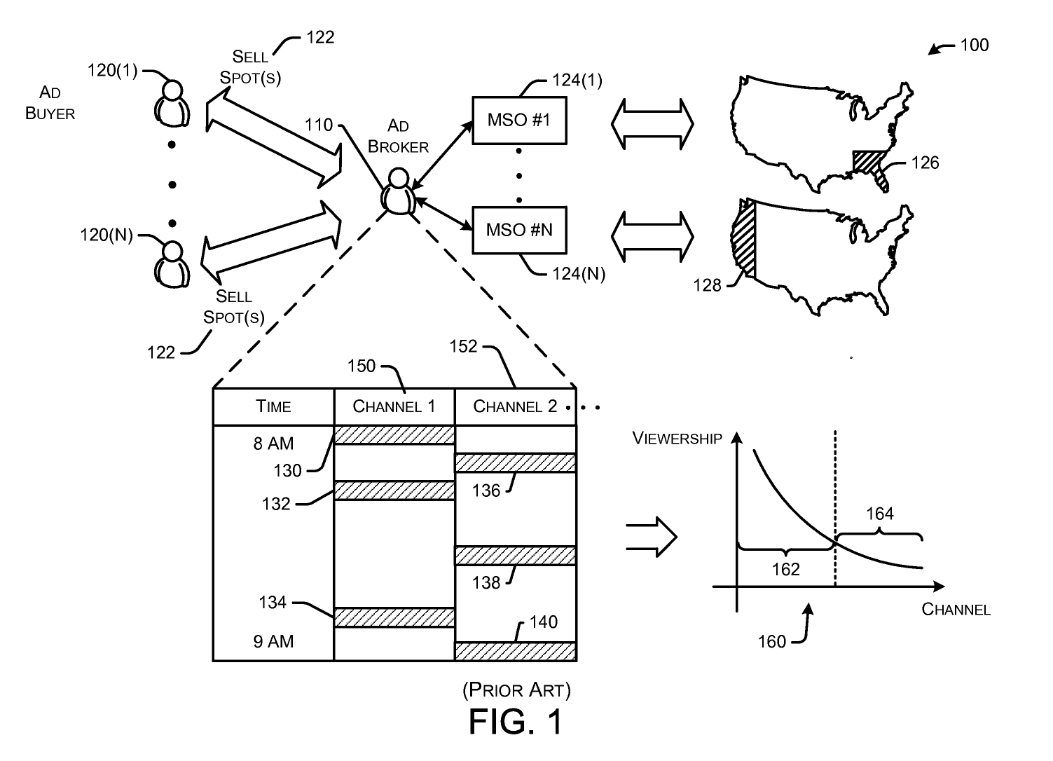

FIG. 2 is a simplified schematic diagram illustrating an example environment for providing an ad demographic bin, in accordance with example embodiments of the disclosure.

FIG. 3 is a simplified block diagram illustrating an example architecture of an ad broker interconnect system, in accordance with example embodiments of the disclosure.

FIG. 4 is a flow diagram illustrating an example method for providing ad demographic and/or geographic bins, in accordance with certain example embodiments of the disclosure.

FIG. 5 is a flow diagram illustrating an example method for generating one or more demographic and/or geographic bin, in accordance with certain example embodiments of the disclosure.

FIG. 6 is a schematic diagram illustrating an example environment with an ad demographic bin sales transaction and advertising in according to the transacted demographic bin, in accordance with certain example embodiments of the disclosure.

### DETAILED DESCRIPTION OF EMBODIMENTS OF THE INVENTION

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the invention to those skilled in the art. Like numbers refer to like, but not necessarily the same or identical, elements throughout.

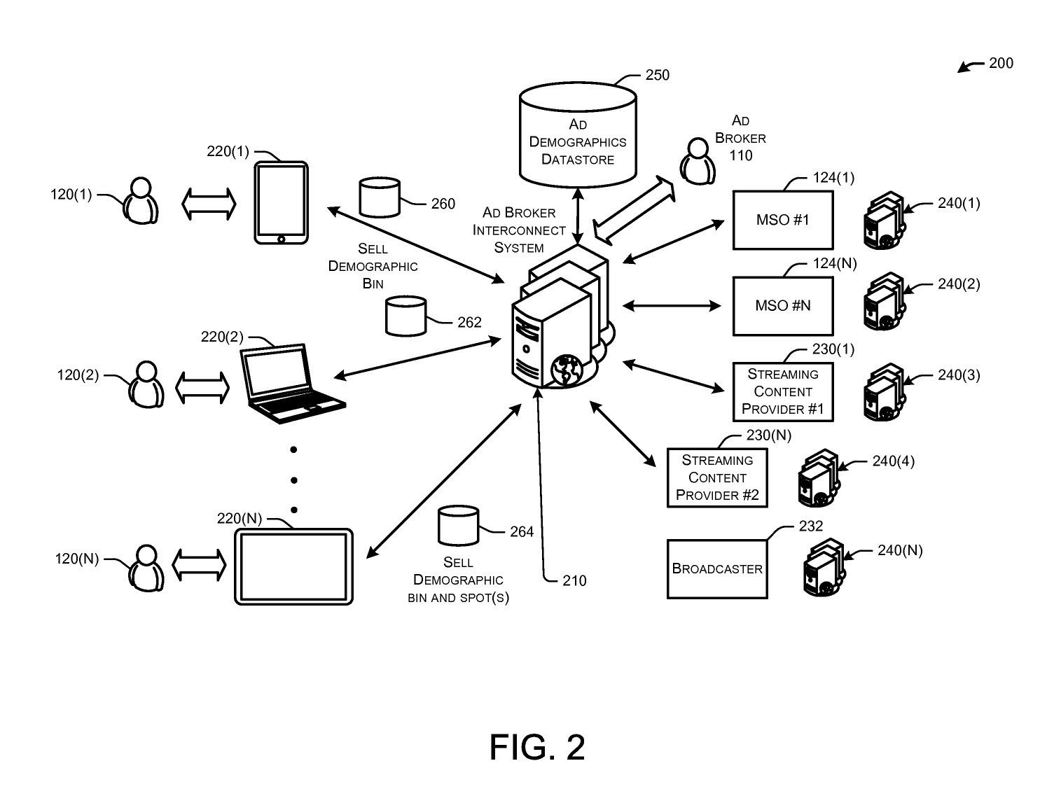

Example embodiments of the disclosure may provide systems, apparatus, and methods for transacting advertisement (ad) demographic bins (also referred to as ad demographic and/or geographic bins). The ad demographic bins that are transacted may correspond to a particular number of impressions, views, interactions, estimated impressions, views, and/or interactions with an ad associated with a particular ad bin. The ad demographic bins may further target a particular demographic group and/or particular geographic location(s) for the number of impressions, views, and/or interactions associated with the ad bin transacted. Furthermore, when an ad demographic bin is transacted, the numeric viewership, demographic, and geographic delivery of those ads may be provided across a variety of channels, content types, and number of spots and/or impressions. The transaction of the ad demographic and/or geographic bins for ads may be better appreciated with reference to FIG. 2.

FIG. 2 is a simplified schematic diagram illustrating an example environment 200 for providing an ad demographic bin, in accordance with example embodiments of the disclosure. The environment 200 may include the ad broker 110 that may be able to interact with an ad broker interconnect system 210. Ad buyers 120 may further be able to interact with the ad broker interconnect system 210 via his/her user device 220(1), 220(2), . . . 220(N), hereinafter referred to collectively or individually as user device 220. The ad broker interconnect system 210 may further be configured to interact with one or more content providers, such as MSOs 124 and/or streaming content providers 230(1), . . . 230(N), hereinafter referred to collectively or individually as streaming content providers 230, or one or more broadcasters 232. The content providers 124, 230, 232 may have corresponding respective content provider servers 240(1), 240(2), 240(3), . . . 240(N), hereinafter referred to collectively or individually as service provider servers 240. The ad broker interconnect system 210 may further be communicatively coupled to an ad demographic datastore 250 that may contain ad related information for that may be received from the content provider servers 240 and/or other ad data sources, such as content viewership reporting services.

The user devices 220 may be any suitable device used by the ad buyers 120 and configured to communicate with the ad broker interconnect system 210 including, but not limited to tablet computing devices, electronic book (ebook) readers, netbook computers, notebook computers, laptop computers, desktop computers, server systems, personal digital assistants (PDA), smart phones, web-enabled televisions, video game consoles, set top boxes (STB), digital video recorder (DVR) systems, combinations thereof, or the like. The user devices 220 may be used by ad buyers 120 for a variety of purposes, such as interacting with the ad broker interconnect system 210 and/or the ad broker 110 to facilitate the purchase of ad demographic bins, view the distribution of spots and/or impressions associated with ad demographic bins, purchase ad spots and/or impressions, combinations thereof, or the like.

The user devices 220 may be configured to communicate with the ad broker interconnect system 210 via one or more networks that may include any one or a combination of different types of suitable communications networks, such as cable networks, the Internet, wireless networks, cellular networks, and other private and/or public networks. Furthermore the networks may include any variety of medium over which network traffic is carried including, but not limited to, coaxial cable, twisted wire pair, optical fiber, hybrid fiber coaxial (HFC), microwave terrestrial transceivers, radio frequency communications, satellite communications, or combinations thereof.

In example embodiments the content provider servers 240 may be one or more media provider servers, such as, for example, a video back office (VBO) server or a streaming media server. The content provider servers 240 may, in certain example embodiments, be configured to provide a variety of statistics to the ad broker interconnect system 210. These statistics may be communicated from the content provider servers 240 via one or more networks as described above. The statistics may include information such as viewership or predicted viewership of a particular content channel associated with a particular content provider 124, 230, 232 and/or interactions or predicted interaction with a particular ad. For example, a particular MSO 124 and its associated content provider server 240 may be configured to provide statistics associated with past viewership of one or more content channels. In some cases, these viewership statistics may be provided for individual media content and/or shows. In another example, a particular MSO 124 and associated content provider server 240 may be configured to provide viewership statistics associated with video-on-demand (VOD) or pay-per-view content. In yet another example, a particular streaming content provider 230 and its associated content provider server 240 may be configured to provide updated statistics on the number of views of a particular media content. In still another example, a particular streaming content provider 230 and its associated content provider server 240 may be configured to provide information related to user interactions, such as click-through, associated with a displayed ad. In these aforementioned examples, the content provider servers 240 may be configured to provide demographic information associated with the viewership statistics provided. This demographic information may be related to a variety of suitable identifiers associated with viewers of a particular content and/or channel of a content provider 124, 230, 232. Such identifiers may include, but is not limited to, number of people in a viewer's household, gender of the viewers, age of the viewers, race of the viewers, religion of the viewers, sexual orientation of the viewers, political views of the viewers, product or service preferences of viewers, combinations thereof, or the like. For example, a particular content provider server 240 may be configured to identify and/or report that a particular media content may have 4 million viewers, of which 70% are men and 30% are female. In another example, a particular content provider server 240 may be configured to identify and/or report that a particular channel may have 2 million teenage viewers and 1 million viewers that are not teenagers. In yet another example, a particular content provider server 240 may be configured to identify and/or report that a particular channel may have 1 million viewers that are golf enthusiasts.

The content provider servers 240 may further be configured to receive orders and/or reservation of ad spots and/or impressions. For example, a particular content provider server 240 may be configured to receive a reservation and/or order for an ad spot at a particular time, particular channel, and/or particular geography of the MSO 124 associated with the content provider server 240. In another example, a particular streaming content provider 230 and its associated content provider server 240 may be configured to receive an order for a particular number of impressions associated with one or more particular content provided by the associated streaming content provider 230. In yet another example, a broadcast content provider 232 and its associated content provider server 240 may be configured to receive a reservation and/or an order a reservation of an ad spot at a particular time, particular channel, and/or particular geography. In example embodiments, reservations and/or purchases of ad spots, impressions, and/or avails may be received by the content provider servers 240 from the ad broker interconnect system 210.

According to example embodiments, the ad broker interconnect system 210 may be configured to identify one or more demographic bins 260, 262. The demographic bin 260, 262 may identify a particular number of ad impressions and/or predicted ad views. The demographic bin 260, 262 may also be associated with a particular demographic of viewers. Further, the demographic bins may be associated with a particular geography. For example, a demographic bin may be identified as impressions or views to 5 million women between the ages of 25 to 34 on the west coast of the United States of America. Another example demographic bin may include 2 million golf-enthusiasts in all of Europe. Yet another example demographic bin may include 20 million children between the ages of 2 and 9 throughout the United States of America.

The ad broker interconnect system 210 may be configured to provide (e.g. sell) one or more demographic bins 260, 262 to one or more ad buyers 120 via their user devices 220. Selling the demographic bin may result in the ad broker interconnect system 210 and the ad broker 110 supplying to the ad buyer 120 the ad based parameters associated with that demographic bin via the rendering of one or more target ad(s) by the content providers 124, 230, 232. In other words, the ad broker system 110 may provision one or more spots, avails, and/or impressions of ads on the content providers 124, 230, 232 to meet the ad based agreements associated with the demographic bins 260, 262 sold to the ad buyers 120. In certain example embodiments, the ad broker 110 by selling an ad demographic bin 260, 262 to a particular ad buyer 120, may be obligated to perform to the terms of that ad demographic bin 260, 262 by delivering the numerical and demographical targets parameterized with the sold ad demographic bin 260, 262. The ad broker 110 and the ad broker system 210 may provide the numerical and demographical targets by provisioning one or more spots, impressions, and/or avails with one or more content providers 124, 230, 232 on behalf of the ad buyer 120. According to some further example embodiments of the disclosure, the ad broker interconnect system 210 may also be configured to provide (e.g. sell) both ad demographic bin(s), as well as individual spots and/or impressions 264.

These concepts may be better understood by way of examples. As a non-limiting example, consider that a particular ad buyer 120 purchases a demographic bin that includes 10 million views by men between the ages of 17 and 39 in the United States of America to show a 30 second ad. In certain example embodiments, by selling this demographic bin, the ad broker interconnect system 210 may be required to provide 10 million views of the 30 second ad to men between the ages of 17 and 39 spread across the United States. In some example cases, the ad broker interconnect system 210 may collect payment for the demographic bin 260, 262 sold to the ad buyer 120 prior to performing to the terms and/or parameters of the demographic bin. In certain other example cases, the ad broker interconnect system 210 may collect payment for the demographic bin 260, 262 sold to the ad buyer 120 after performing to the terms and/or parameters of the demographic bin.

Continuing with the example, the ad broker interconnect system 210 along with the ad broker 110 may acquire a combination of one or more spots with the MSOs 124, spots with the broadcasters 232, and/or impressions with streaming content providers 230 where the 30 second ad may be rendered to meet the terms of the example ad demographic bin. In one example, this may be accomplished by purchasing spots on multiple MSOs 124, the combination of which have a geographic reach throughout the United States of America, such as spots associated with content generally viewed by the target demographic. The spots acquired may total an expected viewership of 10 million men between the ages of 17 and 39. In another example of the ad broker interconnect system 210 performing to the example demographic bin, impressions prior to and/or during streaming media delivery of relatively male oriented content (i.e. sports, cars, men's health, etc. related content) may be acquired from one or more streaming content providers 230 along with spots across the United States of America on similar male oriented content on one or more MSOs 124 and/or broadcasters 232. The combination of the acquired spots and/or streaming media impressions may result in a sum of 10 million expected views by males between the ages of 17 to 39.

In certain example embodiments, the ad broker interconnect system 210 may provide payment for the acquired spots and/or impressions on the variety of content providers 124, 230, 232 upon acquiring the spots and/or impressions and prior to rendering the ad during those acquired spots and/or when the number of impressions have been met/delivered. In certain other example embodiments, the ad broker interconnect system 210 may provide payment for the acquired spots and/or impressions on the variety of content providers 124, 230, 232 only after the ad has been rendered during those acquired spots and/or when the number of impressions have been met/delivered. It will be appreciated that in certain example embodiments, the cost of acquiring the spots and/or impressions on the variety of content providers 124, 230, 232 by the ad broker 110 may be relatively less than the revenue generated by selling the corresponding demographic bin, resulting in a profit for the ad buyer 110.

It will be appreciated that there may be substantial overlap in the viewership demographics associated with certain content provided by the content providers. For example, a channel may have a 70% viewership by males and 30% viewership by females. This particular channel may be bundled in an ad demographic bin targeting men in some cases and in an ad demographic bin targeting women in other cases. However, in cases such as this, an ad broker interconnect system 210 may be configured to determine that allocating spots in this particular channel to ad demographic bins associated with men may be a relatively more effective way to achieve the delivery of the conditions of a plurality of ad demographic bins sold across a plurality of ad buyers 120. In other words, the systems and methods disclosed herein may, in certain example embodiments, inherently encourage an ad broker 110 and/or an ad broker interconnect system 210 to efficiently target ad assets (avails, impressions, spots, etc.) to ad buyers' 120 numerical and/or demographical requirements. The targeting and/or associating ad assets to ad demographical bins may be performed based on a variety of viewership data, such as viewership data that may be received, managed, analyzed, and/or stored, such as in the ad demographics datastore 250, by the ad broker interconnect system 210. In certain example embodiments, the variety of viewership data may be received by the ad broker interconnect system 210 from the content providers 124, 230, 232, and/or associated content provider servers 240. In other example embodiments, the variety of viewership data may be received by the ad broker interconnect system 210 from one or more third party sources, such as The Nielsen Company®.

In some example embodiments, the allocation of ad assets to ad demographic bins may involve one or more algorithms to optimize and/or pseudo-optimize the effectiveness, such as the monetization, of a collection of ad assets. These algorithms may include a variety of regression analysis, linear regression analysis, artificial intelligence algorithms, filtering algorithms, a variety of heuristics, principal component analysis, combinations thereof, or the like. In some example cases, the allocation of ad assets to ad demographic bins may be based at least in part on the current prices of particular ad demographic bins. As the prices, of ad demographic bins may be quite dynamic based on current supply and demand of those ad demographic bins, it will be appreciated that the allocation of ad assets to particular demographic bins may also be relatively dynamic and may vary with time. In other example cases, the algorithms for allocation of ad assets to ad demographic bins may further consider and/or optimize the monetization of ad assets associated with the channels with relatively lower viewership 164, as that may provide greater incremental revenue from available ad assets. In yet further example cases, the algorithms for allocation of ad assets to ad demographic bins may further consider and/or optimize based at least in part on the current availability and pricing to ad assets. For example, if a price-per-view for a male viewer is relatively lower on the Discovery Channel® relative to ESPN®, then the ad broker interconnect system 210 may determine that it may be more effective to allocate Discover Channel® spots versus ESPN® spots to an ad demographic bin that specifies male viewers until doing so brings about rationalization and/or parity of cost between the two choices of this example.

It will be further appreciated that when the ad broker interconnect system 210 acquires targeted spots and/or impressions, channels with relatively lower viewership 164 and/or content with relatively lower viewership may be more effectively targeted by the demographic bins mechanism, rather than by ad buyers 120 purchasing individual spots. In other words, an individual ad buyer 120 may not have the time and/or the resources to analyze much of the content and/or channels with relatively low viewership to place spots and/or impressions thereon. However, if the ad buyer 120 identifies a target demographic and purchases a demographic bin for rendering their ad in accordance with that demographic bin, then the task of distributing the rendering of their ad and the demographic targeting may be performed by the ad broker interconnect system 210. Therefore, the burden of having to distribute the ad rendering by the ad buyer 120 over a variety of channels and/or content may be reduced. Furthermore, the ad broker interconnect system 210 may be able include more of the channels with relatively lower viewership and/or content of relatively lower viewership in the assembly of the ad demographic bins offered for sale to the ad buyers 120 by the ad broker 110. In some cases, the systems and methods as described herein may provide for a better distribution and/or usage of advertising opportunities on the relatively lower viewership channels 164 and/or content. This may especially be true compared to systems where individual users may have to purchase spots from individual content distributers 124, 230, 232. Therefore, in some cases, the advertising avails associated with the relatively lower viewership channels 164 and/or relatively lower viewership content may be better monetized from an advertising standpoint.

It will still further be appreciated that the ad broker 110 and the ad broker interconnect system 210 serves as an interconnect between a variety of media and/or content vectors, each with a variety of content and/or channels, providing content across a variety of geographies, and with viewers with a variety of a variety of interests and demographic profiles. As such, the ad broker 110 and the ad broker interconnect system 210 are configured to provide a package of targeted ad delivery solutions across a wide variety content types, content providers, geographies, and viewers. The ad broker 110 and the ad broker interconnect system 210 is further configured to serve as an interconnect with a variety ad buyers 110. As a result, of the relatively high number of as buyers 110 purchasing ad demographic bins 260, 262 from the ad broker 110, there may be more accurate and/or rational pricing of advertising spots, impressions, and/or avails. Additionally, the systems and methods described herein may provide for greater liquidity in the purchase and sales of ad related inventory. Further still, the ad broker 110 and the ad broker interconnect system 210 may, in certain example embodiments, have a relatively high level of flexibility for managing ad avail inventory (i.e. dynamic allocation of ad avail assets), compared to a mechanism that may provide only for spot and/or impression sales (i.e. static sales and commitment of ad avail assets).

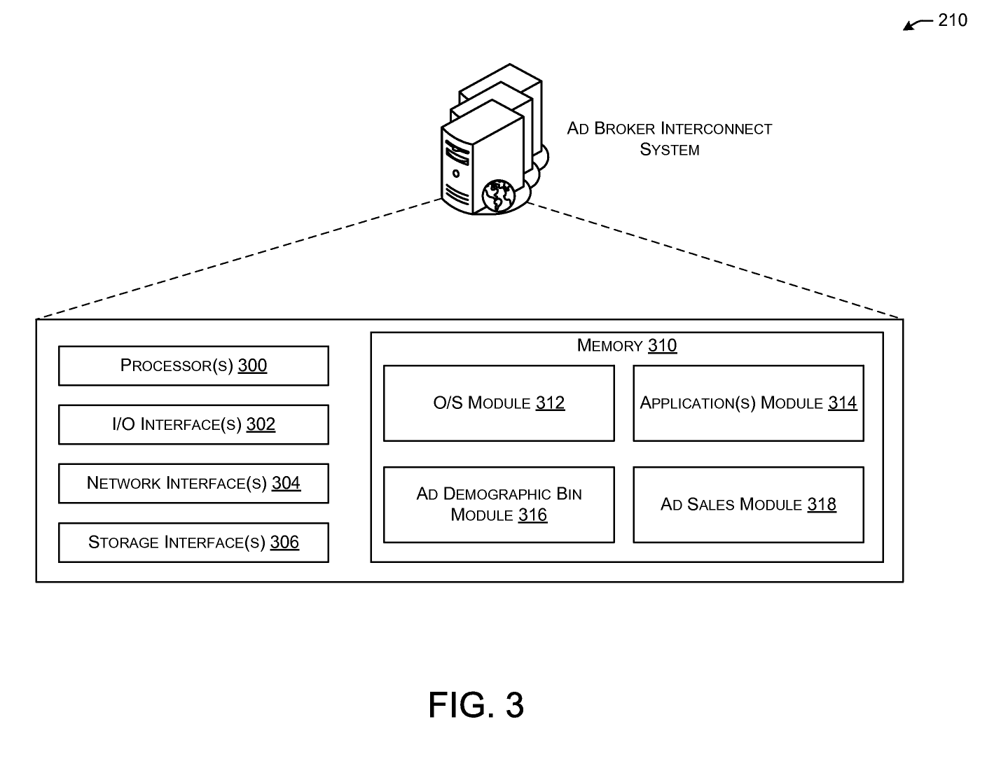

The architecture of the ad broker interconnect system 210 may be better understood with reference to FIG. 3. FIG. 3 is a simplified block diagram illustrating an example architecture of the ad broker interconnect system 210, in accordance with example embodiments of the disclosure. The ad broker interconnect system 210 may include one or more processors 300, one or more input/output (I/O) interfaces 302, one or more network interfaces 304, and one or more memories 310.

The one or more I/O device interfaces 302 may enable the use of one or more (I/O) device(s) or user interface(s), such as a keyboard and/or mouse. An ad broker 110 may be able to administer the systems and methods disclosed herein by interacting with ad broker interconnect system 210 via the I/O device interfaces 302. The network interfaces(s) 304 may allow the ad broker interconnect system 210 to communicate via the one or more network(s) and/or via other suitable communicative channels. In example embodiments, the network interfaces 304 may enable the ad broker interconnect system 210 to communicate with one or more content provider servers 240 and/or user devices 220 via one or more networks, such as the Internet. The storage interfaces 306 may enable the ad broker interconnect system 210 to communicate and/or use one or more storage devices, such as, for example the ad demographics datastore 250.

The processors 300 of the ad broker interconnect system 210 may be implemented as appropriate in hardware, software, firmware, or combinations thereof. Software or firmware implementations of the processors 300 may include computer-executable or machine-executable instructions written in any suitable programming language to perform the various functions described. Hardware implementations of the processors 300 may be configured to execute computer-executable or machine-executable instructions to perform the various functions described. The one or more processors 300 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The ad broker interconnect system 210 may also include a chipset (not shown) for controlling communications between one or more processors 300 and one or more of the other components of the ad broker interconnect system 210. The processors 300 may also include one or more application specific integrated circuits (ASICs) or application specific standard products (ASSPs) for handling specific data processing functions or tasks.

The memory 310 may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The memory 310 may store program instructions that are loadable and executable on the processor(s) 300, as well as data generated or received during the execution of these programs. Turning to the contents of the memory 310 in more detail, the memory 310 may include one or more operating systems (O/S) module 312, an applications module 314, an ad demographic bin module 316, and an ad sales module 318. Each of the modules and/or software may provide functionality for the ad broker interconnect system 210, when executed by the processors 300. The modules and/or the software may or may not correspond to physical locations and/or addresses in memory 310. In other words, the contents of each of the modules 312, 314, 316, 318 may not be segregated from each other and may, in fact be stored in at least partially interleaved positions on the memory 310.

The O/S module 312 may have one or more operating systems stored thereon. The processors 300 may be configured to access and execute one or more operating systems stored in the (O/S) module 312 to operate the system functions of the ad broker interconnect system 210. System functions, as managed by the operating system may include memory management, processor resource management, driver management, application software management, system configuration, and the like. The operating system may be any variety of suitable operating systems including, but not limited to, Google® Android®, Microsoft® Windows®, Microsoft® Windows® Server®, Linux, Apple® OS-X®, or the like.

The application(s) module 314 may contain instructions and/or applications thereon that may be executed by the processors 300 to provide one or more functionality associated with the aggregation of ad assets into ad demographic bins, sales of demographic bins, and procurement of ad assets to fulfill the terms of the sold ad demographic bins. These instructions and/or applications may, in certain aspects, interact with the (O/S) module 312 and/or other modules of the ad broker interconnect system 210. The applications module 314 may have instructions, software, and/or code stored thereon that may be launched and/or executed by the processors 300 to execute one or more applications and functionality associated therewith. These applications may include, but are not limited to, functionality such as web browsing, business, communications, graphics, word processing, publishing, spreadsheets, databases, gaming, education, entertainment, media, project planning, engineering, drawing, or combinations thereof.

The ad demographic bin module 316 may have instructions stored thereon that, when executed by the processors 300, enable the ad broker interconnect system 210, to perform various functions related to creating ad demographic bins 260, 262, associating ad assets to the created ad demographic bins 260, 262, and performing to the parameters of the ad demographic bins 260, 262. The processors 300 may be configured to name and/or assign parameters to create an ad demographic bin. This ad demographic bin 260, 262 may have one or more parameters that identify the delivery of ad metrics and/or demographics to the owner and/or purchaser of the ad demographic bin 260, 262, such as the ad buyer 120. The parameters may include, for example, the number of ad views, the number of ad interactions, demographics associated with the viewers, and/or geography associated with the viewers. The demographics may include, for example, number of people in a viewer's household, gender of the viewers, age of the viewers, race of the viewers, religion of the viewers, sexual orientation of the viewers, political views of the viewers, product or service preferences of viewers, combinations thereof, or the like. In one sense, the processors, by creating the ad demographic bins may be configured to tie together numerical targets, demographical targets, and geographical targets.

The processors 300 may further be configured to associate one or more ad assets (e.g. spots, avails, impressions, etc.) available from the content providers 124, 230, 232 to a created and/or pre-existing ad demographic bin 260, 262. The ad assets may, therefore, be acquired by the processors 300 on behalf of the owner of the ad demographic bin 260, 262, such as the buyer of the ad demographic bin 260, 262. In certain example embodiments, the processors may be configured to dynamically allocate available ad assets to ad demographic bins sold to ad buyers 120. For example, when the ad buyer 120 wishes to render a particular ad, the processors 300 may identify an appropriate ad asset at that time to allocate to the ad buyer 120 and his/her purchased ad demographic bin. In other example embodiments, the processors 300 may be configured to pre-allocate ad assets to a particular ad demographic bin 260, 262 at the time of creating the ad demographic bin 260, 262. It will be appreciated that the processors 300 may be configured to optimize, such as by using a variety of algorithms, to provide the terms and parameters of the ad demographic bin 260, 262 by expending as little funds as possible to acquire the ad assets on behalf of the ad demographic bin 260, 262 owner, such as the ad buyer 120. In other words, the processors may be configured to identify arbitrage opportunities in ad assets, such as opportunities where particular demographic targets may be acquired for a relatively lower cost per view than other ad assets. In some cases, the processors 300 may be configured to identify arbitrage opportunities in the relatively lower viewed channels 164, leading to better monetization of viewers on those content channels and platforms. The processors 300, may yet further be configured to provide funding, or initiate funding, to the content providers 124, 230, 232 for the funding of ad assets acquired on behalf of the ad demographic bin purchaser, such as the ad buyer 120.

The processors 300 may yet further be configured to determine if the stipulated delivery parameters have been met. In other words, the processors 300 may be configured to determine if the number of views of a particular demographic and/or geography have been fulfilled. In some cases, the processors 300 may be configured to transmit a message to the ad buyer via his/her user device 220 via one or more networks to indicate to him/her that the terms of the ad demographic bin have been met.

The ad sales module 318 may have instructions stored therein that may be executed by the processors 300 to provide functionality associated with selling ad demographic bins. The processors 300 may present to an ad buyer 120 via his/her user device 220 and via one or more networks, such as the Internet, information associated with ad demographic bins available for purchase from the ad broker 110 and the ad broker interconnect system 210. In some example embodiments, the processors 300 may be configured to receive requests, such as potential target demographics and/or geography form the ad buyer 120 and create an ad demographic bin based thereon. The processors 300, may yet further be configured to receive funding, or initiate receipt of funding, from the ad buyer 120 for the acquisition of the ad demographic bin.

It will be appreciated that there may be overlap in the functionality of the instructions stored in the operating systems (O/S) module 312, the applications module 314, the ad demographic bin module 316, and the ad sales module 318. In fact, the functions of the aforementioned modules 312, 314, 316, 318 may interact and cooperate seamlessly under the framework of the ad broker interconnect system 210. Indeed, each of the functions described for any of the modules 312, 314, 316, 318 may be stored in any module 312, 314, 316, 318 in accordance with certain embodiments of the disclosure. Further, in certain embodiments, there may be one single module that includes the instructions, programs, and/or applications described within the operating systems (O/S) module 312, the applications module 314, the ad demographic bin module 316, and the ad sales module 318.

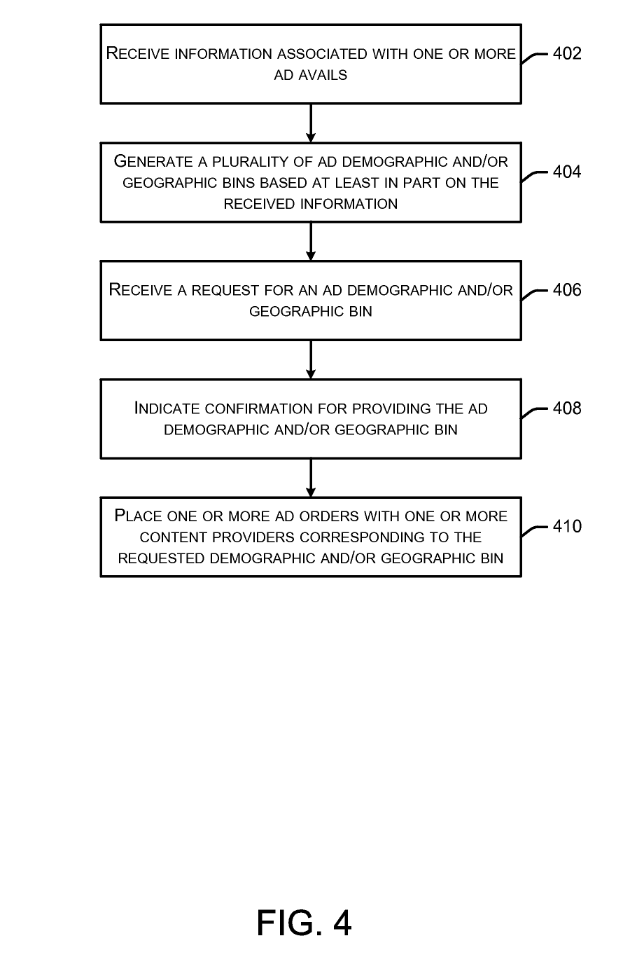

FIG. 4 is a flow diagram illustrating an example method 400 for providing ad demographic and/or geographic bins, in accordance with certain example embodiments of the disclosure. In certain example embodiments, the method 400 may be performed by the ad broker interconnect system 210 and the processors 300 thereon. The ad broker interconnect system 210, in performing the method 400, may interact with the ad broker 110 during one or more processes of method 400.

At block 402, information one or more ad avails may be received. These ad avail information may be received by the ad broker interconnect system 210 and the processors 300 thereon via one or more networks from the content providers 124, 230, 232 and/or associated content provider servers 240. In this case, the ad avails may be any variety of slots where ads may be inserted for rendering, including, but not limited to spots associated with the content providers 124, 230, 232. The ad avails may further include slots prior to, during, overlaid with, or after rendering streaming media, digital, and or video-on-demand (VOD) content.

At block 404, a plurality of demographic and/or geographic bins may be generated based at least in part on the received information of block 402. As described above, the ad avails may be combined to generate suitable ad demographic bins that may specify a variety of parameters such as numerical, demographical, and/or geographical parameters. The generation of this ad demographic bin may provide for interconnecting a variety of content provider platforms and/or geographies to provide a customized ad buying package and/or experience.

At block 406, a request for an ad demographic and/or geographic bin may be received. This may be received from an ad buyer 120 as a message, such as a message including one or more data packets, via his/her user device 220 and via one or more networks, such as the Internet. The request for the ad demographic bin may provide an identifier, such as a unique identifier, associated with the ad demographic bin. In some cases, the ad demographic request may include one or more parameters associated with the ad demographic bin

At block 408, a confirmation for providing the ad demographic and/or geographic bin may be indicated. This confirmation may be transmitted by the ad broker interconnect system 210 as a message, such as a message including one or more data packets, via one or more networks to the ad buyer's user device 220 and/or financial institution.

At block 410, one or more ad orders with one or more content providers corresponding to the requested demographic and/or geographic bin may be placed. These orders may be to purchase, on behalf of the ad demographic bin buyer, ad avails for rendering ads. These purchased ad avails may be used by the ad broker interconnect system 210 to meet the stipulated metrics and/or parameters associated with the sold ad demographic bin.

It should be noted, that the method 400 may be modified in various ways in accordance with certain embodiments of the disclosure. For example, one or more operations of method 400 may be eliminated or executed out of order in other embodiments of the disclosure. Additionally, other operations may be added to method 400 in accordance with other embodiments of the disclosure.

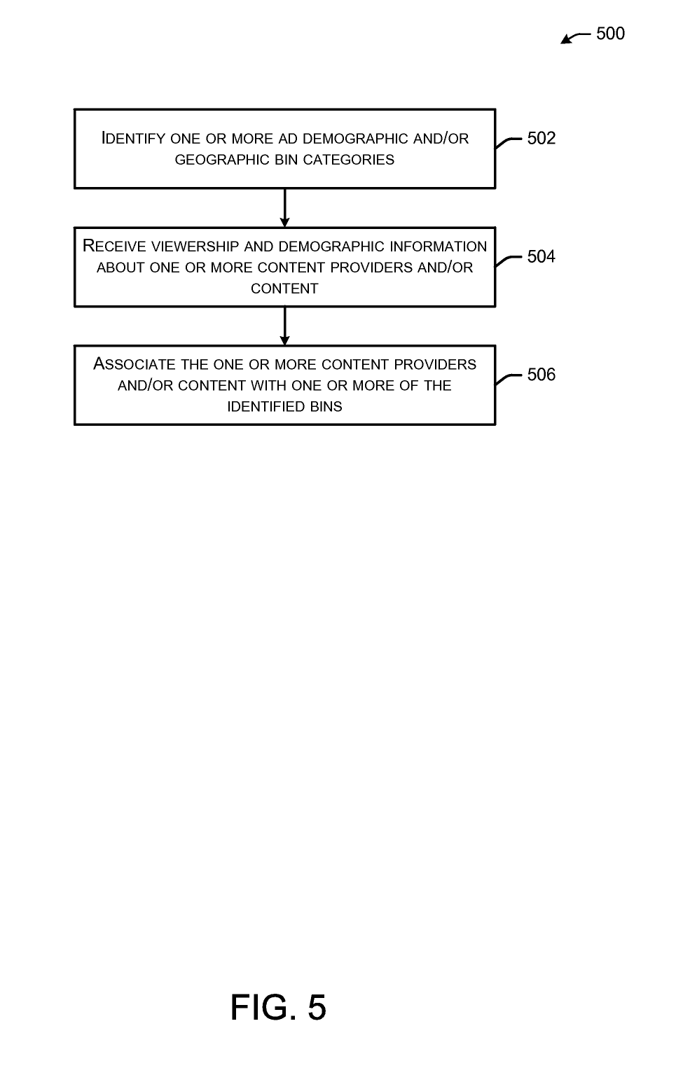

FIG. 5 is a flow diagram illustrating an example method 500 for generating one or more demographic and/or geographic bin, in accordance with certain example embodiments of the disclosure. Method 500 may be an example implementation of the process of block 404 of method 400 of FIG. 4, according to example embodiments of the disclosure. In certain example embodiments, the method 500 may be performed by the ad broker interconnect system 210 and the processors 300 thereon. The ad broker interconnect system 210, in performing the method 500, may interact with the ad broker 110 during one or more processes of method 500.

At block 502, one or more ad demographic and/or geographic bin categories may be identified. This identification may be by the ad broker 110 creating ad demographic bin categories and/or parameters. Ad brokers 110 may create these categories based on some knowledge and/or historical information related to ad asset inventories. Alternatively, demographical demand from ad buyers 120 for particular demographic targets may be used at least in part for creating ad demographic bin categories.

At block 504, viewership and demographic information about one or more content providers and/or content may be received. This viewership and demographic information may be received from the content providers 124, 230, 232 and associated content provider servers 240 or from third party sources, such as an aggregator and/or reporter of media-based statistics. This information may indicate demographical affiliation of viewers of the content. At block 506, the one or more content providers and/or content may be associated with one or more of the identified bins. This association may be based at least in part on determining efficient ways to provide the terms and/or parameters of the ad demographic bin. One or more algorithms may be used to determine optimized allocations of content and associated ad avails to particular ad demographic bins. These algorithms may include a variety of regression analysis, linear regression analysis, artificial intelligence algorithms, filtering algorithms, a variety of heuristics, principal component analysis, combinations thereof, or the like. The algorithms may further take into account the current and/or expected future prices of ad demographic bins and/or ad assets to be associated with the ad demographic bins.

It should be noted, that the method 500 may be modified in various ways in accordance with certain embodiments of the disclosure. For example, one or more operations of method 500 may be eliminated or executed out of order in other embodiments of the disclosure. Additionally, other operations may be added to method 500 in accordance with other embodiments of the disclosure.

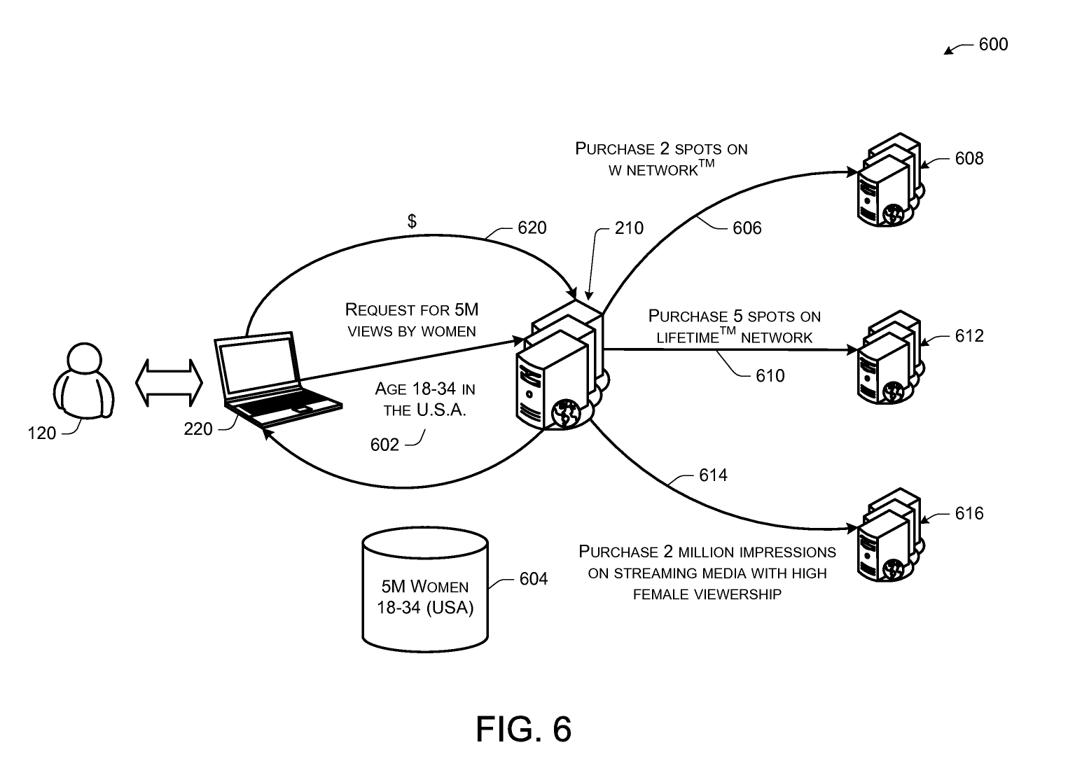

FIG. 6 is a schematic diagram illustrating an example environment 600 with an ad demographic bin sales transaction and advertising in according to the transacted demographic bin, in accordance with certain example embodiments of the disclosure. The transactions as displayed in environment 600 may be between one or more of the ad buyers 120 and their user devices 220, the content provider servers 240, and the ad broker interconnect system 210.

As depicted, the ad demographic bin sales transaction may entail a request for an ad demographic bin 602 transmitted from the user device 220 to the ad broker interconnect system 210. The request for the ad demographic bin 602 may be prompted by the ad buyer 120 by interacting with his/her user device 220. The request for the ad demographic bin 602 may, in certain example embodiments, be a message in the form of one or more data packets and transmitted to the ad broker interconnect system 210 via one or more communications networks.

In response to the request for the ad demographic bin 602, the ad broker interconnect system 210 may provide an indication of the sale of the ad demographic bin 604. Upon sales of the ad demographic bin 604 to the ad buyer 120, the ad broker interconnect system 210 may be obligated to perform to the parameters, such as numerical and demographical parameters of the ad demographic bin 602 that was sold to the ad buyer 120. In this case, the ad broker interconnect system 210 and the associated ad broker 110 may be obligated to provide 5 million views of one or more ads of the ad buyer 120 to a demographic group of women between the ages of 18 and 34 throughout the United States of America. In some example cases, the ad broker interconnect system 210 and/or the associated ad broker 210 may be contractually obligated to provide and/or perform to the parameters of the ad demographic bin 604 sold to the ad buyer.

To perform (i.e. provide the stipulated number of impressions to the target demographic) in accordance with the ad demographic bin 604 sold to the ad buyer 120 via his or her user device 220, the ad broker interconnect system 210 may acquire a plurality of spots and/or impressions on content provider systems (i.e. MSOs, broadcasters, digital/streaming media providers) via their respective content provider servers 608, 612, 616. In this case, the ad broker interconnect system 210 may acquire ad avails and/or assets associated with content that may primarily be consumed by the target demographic, namely women between the ages of 18-34 in the United States of America. Therefore, the ad broker interconnect system 210 may acquire ad assets associated with content that may appeal to the target demographic. In this example, the ad broker interconnect system 210 may acquire two spots on the W Network™ 606, five spots on the Lifetime Network™ 610, and two million impressions on streaming media content with high female viewership 616.

The ad assets 606, 610, 614 acquired by the ad broker interconnect system 210 on behalf of the ad buyer 120 may be used by the ad buyer to display one or more ads, such as ads related to a particular product or service. Upon performing to the terms of the ad demographic bin 604, the ad broker interconnect system 210 may receive payment 620 from the ad buyer 120. It will be appreciated that the ad broker interconnect system 210 serves as an interconnect for acquiring ad assets from a plurality of content distributers. In some cases this structure enables the efficient acquisition, deployment, and/or monetization of ad assets across a variety of different content distributers that may otherwise be geographically and/or demographically fragmented. It will further be appreciated that certain content providers, particularly broadcasters 232, may be relatively highly fragmented from a geographic standpoint. This geographic fragmentation may make it especially difficult for an ad buyer to acquire ad assets from these geographically fragmented content providers, such as broadcasters 232, in an efficient manner. It will be appreciated that the systems and methods as disclosed herein may enable a relatively efficient mechanism for acquire ad assets across a variety of geographically fragmented content providers 124, 230, 232.

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method, comprising:
receiving, by an advertisement (ad) broker interconnect system comprising one or more processors, a request to acquire an ad demographic bin corresponding to one or more ad parameters;
providing, by the ad broker interconnect system and responsive to the request to acquire the ad demographic bin, the ad demographic bin;
associating, by the ad broker interconnect system and based at least in part on the one or more ad parameters, the ad demographic bin with one or more ad avails available with one or more content providers; and
providing, by the ad broker interconnect system to the one or more content providers, an indication of at least one advertisement to be rendered in the one or more ad avails.

2. The method of claim 1, wherein the request to acquire an ad demographic bin is associated with an ad buyer.

3. The method of claim 1, wherein the one or more ad parameters include at least one of: (i) a target number of impressions; (ii) a target number of people in a viewers' household; (iii) a target gender of the viewers; (iv) a target age of the viewers; (v) a target age range of the viewers; (vi) a target race of the viewers; (vii) a target religion of the viewers; (viii) a target sexual orientation of the viewers; (ix) target political views of the viewers; (x) target product or service preferences of viewers; or (xi) a target geography of the viewers.

4. The method of claim 1, wherein providing the ad demographic bin further comprises transmitting, by the ad broker interconnect system, a confirmation of acquiring the ad demographic bin to an ad buyer associated with the request to acquire an ad demographic bin.

5. The method of claim 1, further comprising receiving, by the ad broker interconnect system, a first payment from an ad buyer associated with the request to acquire an ad demographic bin.

6. The method of claim 1, further comprising identifying, by the ad broker system, information associated with respective media content corresponding to the one or more ad avails associated with the one or more content providers.

7. The method of claim 6, wherein associating the ad demographic bin with the one or more ad avails further comprises comparing the information associated with respective media content corresponding to the one or more ad avails with the one or more parameters.

8. The method of claim 6, wherein the information associated with the respective media content corresponding to the one or more ad avails are received from at least one of: (i) the one or more content providers or (ii) a third party source.

9. The method of claim 1, wherein providing an indication of at least one advertisement to be rendered in the one or more ad avails further comprises providing, by the ad broker interconnect system, one or more second payments to the one or more content providers.

10. One or more computer-readable media comprising computer-executable instructions that, when executed by one or more processors, configure the one or more processors to perform a method comprising:
receiving a request to acquire an ad demographic bin corresponding to one or more ad parameters;
providing, responsive to the request to acquire the ad demographic bin, the ad demographic bin;
associating, based at least in part on the one or more ad parameters, the ad demographic bin with one or more ad avails available with one or more content providers; and
providing, to the one or more content providers, an indication of at least one advertisement to be rendered in the one or more ad avails.

11. The one or more computer-readable media of claim 10, wherein the one or more ad parameters include at least one of: (i) a target number of impressions; (ii) a target number of people in a viewers' household; (iii) a target gender of the viewers; (iv) a target age of the viewers; (v) a target age range of the viewers; (vi) a target race of the viewers; (vii) a target religion of the viewers; (viii) a target sexual orientation of the viewers; (ix) target political views of the viewers; (x) target product or service preferences of viewers; or (xi) a target geography of the viewers.

12. The one or more computer-readable media of claim 10, wherein the method further comprises identifying information associated with respective media content corresponding to the one or more ad avails associated with the one or more content providers.

13. The one or more computer-readable media of claim 12, wherein associating the ad demographic bin with the one or more ad avails further comprises comparing the information associated with respective media content corresponding to the one or more ad avails with the one or more parameters.

14. The one or more computer-readable media of claim 12, wherein the information associated with the respective media content corresponding to the one or more ad avails are received from at least one of: (i) the one or more content providers or (ii) a third party source.

15. A system for managing advertising, comprising:
at least one memory for storing computer-executable instructions;
at least one processor in communication with the at least one memory, wherein the at least one processor is configured to execute the computer-executable instructions perform a method comprising:
receiving indication of a plurality of ad avails from one or more content providers;
identifying respective demographic information corresponding to each of the plurality of ad avails;
associating one or more of the plurality of ad avails to an ad demographic bin based at least in part on the demographic information corresponding to each of the plurality of ad avails; and
providing the ad demographic bin to an ad buyer, wherein providing the ad demographic bin comprises a commitment to perform to one or more terms of the ad demographic bin.

16. The system for managing advertising of claim 15, wherein the respective demographic information corresponding to each of the plurality of ad avails further corresponds to a respective media content corresponding to each of the plurality of ad avails.

17. The system for managing advertising of claim 15, wherein the respective demographic information corresponding to each of the plurality of ad avails comprises an indication of demographic information associated with viewers of the respective media content corresponding to each of the plurality of ad avails.

18. The system for managing advertising of claim 15, wherein the one or more terms of the ad demographic bin include at least one of: (i) a target number of impressions; (ii) a target number of people in a viewers' household; (iii) a target gender of the viewers; (iv) a target age of the viewers; (v) a target age range of the viewers; (vi) a target race of the viewers; (vii) a target religion of the viewers; (viii) a target sexual orientation of the viewers; (ix) target political views of the viewers; (x) target product or service preferences of viewers; or (xi) a target geography of the viewers.

19. The system for managing advertising of claim 15, wherein performing to the one or more terms of the ad demographic bin comprises acquiring the one or more of the plurality of ad avails on behalf of the ad buyer.

20. The system for managing advertising of claim 15, wherein the respective demographic information corresponding to each of the plurality of ad avails are received from at least one of: (i) the one or more content providers or (ii) a third party source.
